(19) United States
(12) Patent Application Publication
(10) Pub. No.: US 2015/0370674 A1
(43) Pub. Date: Dec. 24, 2015

(54) TENANT PROVISIONING FOR TESTING A PRODUCTION MULTI-TENANT SERVICE

(71) Applicant: Microsoft Corporation, Redmond, WA (US)

(72) Inventors: Florin Lazar, Woodinville, WA (US); Ian C. Marshall, Redmond, WA (US); Victor Urnyshev, Redmond, WA (US); Krishna Srinivasan Iyer, Kirkland, WA (US); Diane K. Rapp, Snohomish, WA (US); Robert A. Land, Kirkland, WA (US)

(73) Assignee: Microsoft Corporation, Redmond, WA (US)

(21) Appl. No.: 14/309,688

(22) Filed: Jun. 19, 2014

(51) Int. Cl. G06F 11/263; G06Q 30/02

(52) U.S. Cl. CPC G06F 11/263; G06Q 30/0207

(57) ABSTRACT

A tenant provisioning system. The system allows users to request creation of test tenants for a multi-tenant service targeting specific infrastructure resources and automated bulk creation of test tenants. Test tenants created by the system are clearly identified as test tenants to prevent test tenants from being misreported by business intelligence systems providing information about the multi-tenant service. Automated provisioning of test tenants on a regular schedule provides a mechanism for monitoring the operation of the multi-tenant service. Further, the ability to provision a test tenant in specific infrastructure resources allows comprehensive operational testing of most or all infrastructure resources, as well as targeted testing of individual infrastructure resources. The system may provide test tenants with an expiration allowing automatic removal of out-of-date test tenants. The system reduces the costs and errors inherent with the manual creation of test tenants.

### BACKGROUND

Large multi-tenant cloud services employ multiple data centers to provide services to customers. Datacenters are geographically distributed. Tenants may be assigned to a datacenter that is geographically close to the tenant's location. The infrastructure of these cloud services is built from multiple networks of server farms and directory service forests. However, variations exist within the infrastructure of the cloud service. For example, different regions may have different languages, and regional versions may be upgraded at different times.

To understand the user experience of in-production systems, test tenants may be manually provisioned using the same user interface that is used to provision tenants for customers using specific naming conventions. However, manual creation of test tenants is time consuming and error prone. Care must be taken to ensure that test tenants are not mistakenly identified as real tenants when it comes to business intelligence, such as revenue reporting and other similar business functions. Moreover, there is no direct control over the network, farm, or forest in which a test tenant is provisioned. While it is possible to influence where a tenant is provisioned through region and language selection, there is no guarantee that any particular network, farm, or forest will be tested.

It is with respect to these and other considerations that the present invention has been made. Although relatively specific problems have been discussed, it should be understood that the embodiments disclosed herein should not be limited to solving the specific problems identified in the background.

### BRIEF SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Embodiments of a tenant provisioning system communicate directly with a commerce platform and a directory service system associated with a multi-tenant service to create and provision tenants in selected service instances. In various embodiments, the tenant provisioning system is a service that may be made available to users associated with the provider of the multi-tenant service. The tenant provisioning system is not available to end users of the multi-tenant service (i.e., users associated with customers).

Embodiments of the tenant provisioning system may be used with an independent workflow system. Embodiments of the workflow system may include a scripting component that allows workflows to be defined. The workflow system may automatically apply workflows to test tenants obtained from the tenant provisioning system and monitor the outcome of such workflows. The workflow system may log the status, actions, and/or outcome of the workflows, produce reports or feeds usable by other systems, and/or send notifications or generate alerts when workflows fail or problems with the multi-tenant system, workloads, service instances, resources, or tenants are identified. In various embodiments, the tenant provisioning system may incorporate some or all of the capabilities and functions of the workflow system.

### BRIEF DESCRIPTION OF THE DRAWINGS

Further features, aspects, and advantages of the present disclosure will become better understood by reference to the following figures, wherein elements are not to scale so as to more clearly show the details and wherein like reference numbers indicate like elements throughout the several views:

FIG. 1 illustrates a system architecture for one embodiment of the tenant provisioning system in a large-scale, multi-tenant service environment;

FIG. 2 is a high-level flowchart of one embodiment of the test tenant provisioning method employed by the tenant provisioning system;

FIG. 3 illustrates the operational flow of one embodiment of the tenant provisioning system to generate test tenants in a selected service instance;

FIG. 4 is a block diagram illustrating one embodiment of the physical components of a computing device with which embodiments of the present invention may be practiced; and

FIGS. 5A and 5B are simplified block diagrams of a mobile computing device with which embodiments of the present invention may be practiced.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems, or devices. Accordingly, embodiments may take the form of a hardware implementation, an entirely software implementation or an implementation combining software and hardware aspects. The following detailed description is, therefore, not to be taken in a limiting sense.

Embodiments of a tenant provisioning system are described herein and illustrated in the accompanying figures. The system allows users to request creation of test tenants for a multi-tenant service targeting specific infrastructure resources and automated bulk creation of test tenants. Test tenants created by the system are clearly identified as test tenants to prevent test tenants from being misreported by business intelligence systems providing information about the multi-tenant service. Automated provisioning of test tenants on a regular schedule provides a mechanism for monitoring the operation of the multi-tenant service. Further, the ability to provision a test tenant in specific infrastructure resources allows comprehensive operational testing of most or all infrastructure resources, as well as targeted testing of individual infrastructure resources. The system may provide test tenants with an expiration allowing automatic removal of out-of-date test tenants. The system reduces the costs and errors inherent with the manual creation of test tenants.

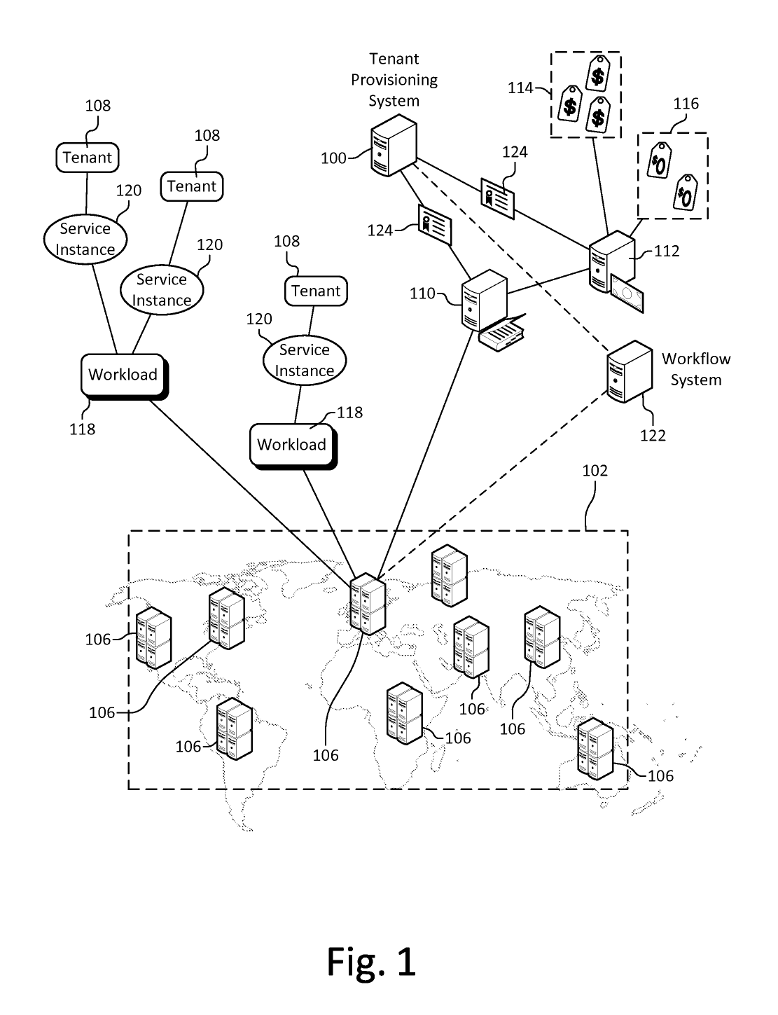

FIG. 1 illustrates a system architecture for one embodiment of the tenant provisioning system 100 in a large-scale, multi-tenant service environment. The multi-tenant service 102 is made up of a number of data centers that host one or more workloads for customers. In the illustrated embodiment, the multi-tenant service is a distributed service, such as a cloud-based service, having multiple, geographically distributed data centers 106. When customers subscribe to the multi-tenant service, a tenant 108 is typically provisioned in a data center that is geographically located near the customer's geographic location. The tenant generally refers to the top level object in the hierarchical representation of a customer (e.g., a company) within the multi-tenant service.

As used herein, the term “real tenant” refers to a tenant created by a customer and “test tenant” refers to a tenant created by the tenant provisioning system when it is meaningful to differentiate based on the origin of the tenant. Generally, once created, there is no meaningful difference between a real tenant and a test tenant from a functionality standpoint, which is desirable as test tenants are intended to be used to mimic real tenants for testing operation of production multi-tenant services. The tenant provisioning system interacts with many of the same systems used to provision real tenants. The primary distinctions are the ability to automate test tenant creation and the level of control provided by the tenant provisioning system during provisioning that allows configuration of various aspects of the test tenant from inception, such as where the test tenant is provisioned or what resources are provisioned to the test tenant, subscribing without actual payment, bulk test tenant provisioning, and ready identification of test tenants by other systems.

A directory service system 110 maintains the information about the organization, resources, and users of the multi-tenant service. The information stored by the directory service system may include, but is not limited to, some or all of domain lists, user lists, security group lists, subscription information, role assignments, license assignments, and service instance properties.

A commerce platform 112 manages the subscriptions to the multi-tenant service. The commerce platform maintains the list of available service plans 114 available to customers, accepts orders to subscribe to available service plans, generates invoices, accepts payments, and provisions plans to tenants. The commerce platform may maintain a list of special subscription offers 116 created for use by the tenant provisioning system exclusively for provisioning test tenants.

The individual services by the multi-tenant service provided to customers are referred to as workloads 118. Examples of workloads for an office or productivity application-based large-scale service, may include, without limitation, word processing, mail, messaging, conferencing, task management, calendaring, collaboration, contact information management, note taking, document management, content management, presentation, spreadsheet, database, media, and drawing application services.

The service instance 120 to which a tenant is provisioned for any workload is assigned when a service plan is provisioned on a tenant. For real tenants, the service instance is selected based on information provided and selections made by the customer during registration. A service instance is the resource unit that a workload exposes to the directory service associated with the multi-tenant service. Each workload defines the scope of the service instance. The service instance is used to identify the workload when the workload queries the directory service for changes. Each service instance has various resources associated with it. Resources are components of the multi-tenant service infrastructure, but not limited to, networks, directory service trees (e.g., accounts or mailboxes), forests of one or more directory service trees, and server farms.

The tenant provisioning system communicates directly with the commerce platform and the directory service to create and provision tenants in selected service instances for business functions, such as, but not limited to, monitoring, testing, maintaining, and upgrading the multi-tenant service. In various embodiments, the tenant provisioning system is a service that may be made available to users associated with the provider of the multi-tenant service. The tenant provisioning system is not available to end users of the multi-tenant service (i.e., users associated with customers). Some embodiments may allow for different levels of access to the tenant provisioning system. For example, standard users may be permitted to perform basic functions such as, without limitation, requesting tenants and creating workflows that generate and monitor a series of tenants. Administrative users may be permitted to perform higher level functions, such as, without limitation, adding new subscriptions to previously provisioned tenants.

In some embodiments, the tenant provisioning system may include a scripting service that allows workflows to be created. Workflows may be used to automate generation of tenants according to a schedule or on a periodic basis and to perform actions with or against the tenants. Various embodiments of the tenant provisioning system may include a logging or reporting service that monitors and records the status and/or activities of the tenant provisioning service (e.g., provisioning and/or de-provisioning of tenants), tenants (e.g., successfully created or migrated), and workflows (e.g., upgrade workflow applied). Embodiments of the logging/reporting service may also generate alerts when problems with the multi-tenant system, workloads, service instances, resources, or tenants are identified.

In addition, embodiments of the tenant provisioning system may be used with an optional independent workflow system 122. Embodiments of the workflow system may include a scripting component that allows workflows to be defined. The workflow system may automatically apply workflows to test tenants obtained from the tenant provisioning system and monitor the outcome of such workflows. Monitoring may be used for functions such as, but not limited to, assessing the health or operation of the multi-tenant service or any component thereof, including workloads, service instances, workflows, farms, forests, trees, networks, application frameworks and application built thereon, and other infrastructure resources, on an on-going or as-needed basis. The workflow system may log the status, actions, and/or outcome of the workflows, produce reports or feeds usable by other systems, and/or send notifications or generate alerts when workflows fail or problems with the multi-tenant system, workloads, service instances, resources, or tenants are identified.

In various embodiments, the tenant provisioning system may incorporate some or all of the capabilities and functions of the workflow system, including applying and monitoring workflows, logging, reporting, and generating alerts. Within the tenant provisioning system, workflows may be used for purposes such as automatic generation of test tenants and/or import information about test tenants according to a schedule or on a periodic basis and generation of test tenants in bulk. The tenant provisioning system may include a database that may serve as a repository for test tenants and information reported about test tenants.

Embodiments of the tenant provisioning system employ secure access to the commerce platform, and/or the directory service to avoid misuse of tenant provisioning system functionality, such as free subscription offers and the ability to target specific infrastructure resources. For example, through unauthorized access to the commerce server, unauthorized free subscription offers may be generated that do not conform to the constraints expected for test tenants, which may result in a loss of ability to distinguish between real and test tenants, or free subscription offers may be misappropriated for use by real tenants, which may result in lost revenue. In another example, unauthorized access to generate test tenants for specific service instances might be exploited to target parts of the multi-tenant service infrastructure with denial of service attacks. Secure access may be provided through the use of security and authentication mechanisms 124, such as, without limitation, permissions, security certificates, authentication tokens, and other security mechanisms suitable for authenticating communications between selected computing devices or from authorized users.

The tenant provisioning system, the commerce platform, the directory service, the workflow system, and the multi-tenant service are implemented using one or more computing devices that execute corresponding computer executable instructions that provide the functionality described herein. The computer executable instructions may be in the form of programs, applications, services, scripts, or other software. The computing devices may be implemented as individual servers or as server farms. The distributed components of the tenant provisioning system and the multi-tenant service communicate via one or more networks, such as, but not limited to, the Internet, wide area networks, and local area networks.

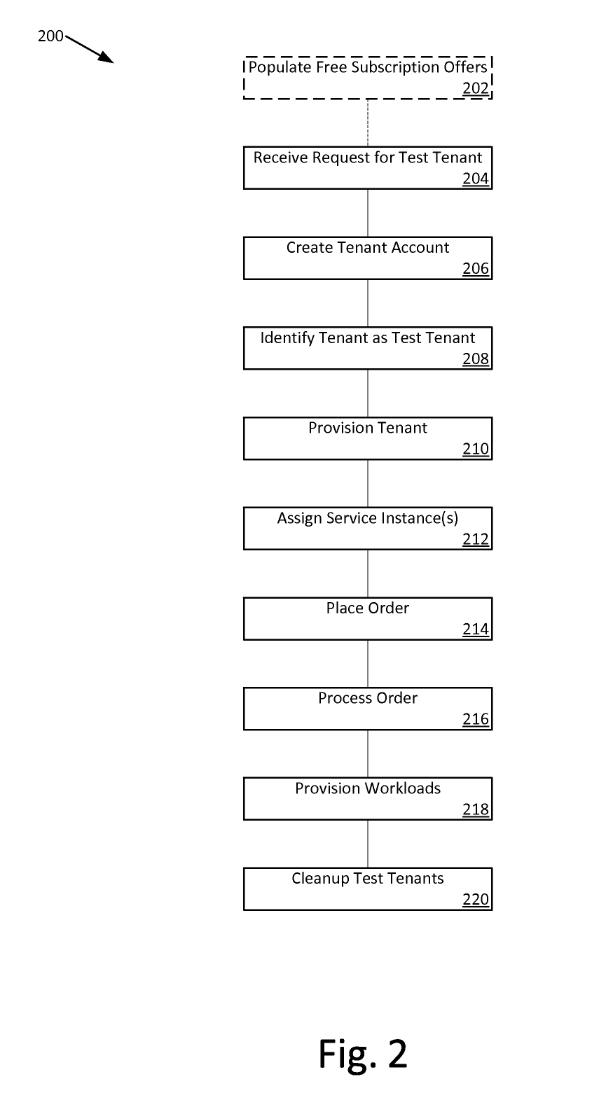

FIG. 2 is a high-level flowchart of one embodiment of the tenant provisioning method employed by the tenant provisioning system. The tenant provisioning method 200 optionally begins with an offer definition operation 202 where a set of special subscription offers is defined in the commerce platform. The special subscription offers are for limited internal use in provisioning test tenants and mimic some or all behaviors of corresponding paid service plans except for billing. In some embodiments, special subscription offers may have renewal or term limitations, such as special termination rules linked to the billing cycle that sets the lifespan of the test tenant.

In some embodiments, a special subscription offer corresponding to each paid subscription plan may be generated. A multi-tenant service may have a large number of paid service plans that are available to customers. In some cases, it may not be practicable or necessary to create a special subscription offer corresponding to each paid subscription plan. Accordingly, in some embodiments, special subscription offers may only be generated for selected paid service plans. For example, the special subscription offers may correspond to the most highly provisioned paid service plans.

Special subscription offers encompass nominal fee (e.g., $0.01 or other substantially reduced amounts) or free (i.e., zero cost) subscription offers. The use of free subscription offers may be particularly beneficial where a large volume of test tenants are generated because costs associated with provisioning the test tenant in the commerce platform may become burdensome. Even if the payments are returned to the funding source (i.e., reimbursed), there may be unrecovered costs in the form of transaction fees (e.g., credit card transaction fees) and/or a requirement of maintaining sufficient funds/credit limits to cover the subscription cost for each test tenant generated.

A provisioning request receipt operation 204 receives a request to provision a test tenant sent by requestor. The requestor may be an automated request system that generates requests on a periodic basis or a user, such as a service developer or support engineer, who generates requests on an as-needed basis to test the functioning of one or more resources of the multi-tenant service. The provisioning request may specify provisioning details (e.g., metadata) for the test tenant, including, but not limited to, settings, resources, and the subscription offer to utilize. The provisioning details may specify characteristics, such as, without limitation, a service instance where the test tenant is to be provisioned, a workload version to use for the test tenant, a database to use for the test tenant, a subscription offer to use when provisioning the test tenant, a specific identifier (i.e., company name), the language of the test tenant, the region for the test tenant, and the lifespan or expiration of the test tenant. Embodiments may also specify a schedule for generating a series of test tenants.

A tenant creation operation 206 generates the tenant information used to create the tenant in the commerce platform based on the content of the provisioning request. The tenant creation operation involves creating and saving the tenant profile and instructing other systems (e.g., the commerce system, the directory service system, or workloads) in the multi-tenant service to behave in certain ways as needed for the desired test scenario. Instructing the other systems may be accomplished by passing metadata specifying an instruction and/or a value (i.e., parameter). Examples of the metadata that may be passed to other systems include, without limitation, an instruction to use a special subscription offer, an instruction to skip billing for the test tenant, an instruction to provision the test tenant with a particular workload version, an instruction to use a specified database for the test tenant, an instruction to use a specified service instance for the test tenant, an instruction to identify the tenant as a test tenant inside the multi-tenant service, and any of the previously described provisioning details.

In various embodiments, the tenant creation operation may be configured to run on a scheduled or periodic basis (e.g., every N minutes, hours, or days) to generate an ongoing sequence of test tenants for heartbeat testing, which allows for continuous monitoring of the operation of service instances. In some embodiments, the tenant creation operation may be called on an as-needed basis to generate test tenants for testing of selected workload instances in response to particular events.

A test tenant identification operation 208 tags the tenant in a manner that allows other systems and services and users to identify the tenant as a test tenant. In various embodiments, information in the tenant profile conforms to conventions used to identify the tenant as a test tenant. Test tenants may need to be identified to a variety of different systems using different test tenant identification conventions. The tenant provisioning system, the commerce platform, and business intelligence systems may all need to distinguish test tenants from real tenants. For example, the tenant information may generate a prefix or suffix for a tenant information field (e.g., company name or initial domain) that conforms to a test tenant identification convention or ensure that a selected string or other value used to identify a test tenant is incorporated into appropriate tenant information field (e.g., company name). In another example, the tenant creation operation may also add one or more tags or populate one or more fields specifically used to identify a tenant as test tenant. Some systems, such as the commerce platform, may identify tenants provisioned using a special subscription offer as test tenants.

One benefit of consistently distinguishing test tenants from real tenants is preventing test tenants from skewing service and financial metrics. For example, failure to account for test tenants might influence decisions about adding resources to the multi-tenant service because test tenants might be misreported as real tenants in figures on new tenants or total number of tenants. Similarly, failure to account for test tenants might result in inaccurate financial statements based on flawed revenue projections based on test tenant subscriptions. One can imagine other undesirable scenarios that might arise from an inability to accurately identify test tenants.

Once created, a tenant provisioning operation 210 provisions the test tenant in the directory service for the multi-tenant service. At this point, the test tenant has been created and administratively provisioned in the multi-tenant service, but no subscriptions have been purchased by the test tenant. In other words, an account for the test tenant has been created, but the test tenant has not been authorized to use any of the workloads provided by the multi-tenant service.

A service instance assignment operation 212 adds service instance(s) to the test tenant prior to provisioning a subscription offer to test tenant. The service instance assignment operation specifies selected service instance(s) where the test tenant is to be provisioned. The service instance assignment operation may also be used to set service instances for a test tenant created for troubleshooting specific service instances of a workload. Tenant migration testing is one example of a scenario where setting specific service instances may be desirable. In a multi-tenant service with a mixed infrastructure having some service instances that are upgrade ready and some that are not, the infrastructure may provide at least one service instance that is in an upgrade ready state. In various embodiments, selected upgrade-ready service instances may be reserved for tenant migration testing and excluded from the service instances where real tenants are provisioned. Because there may be situations where it is not necessary to explicitly set the service instance property, the service instance assignment operation may be optional in some embodiments, for example, when testing the operation of an upgrade workflow for a workload where all services instances are always upgrade ready.

After any specific service instances for the test tenant have been set, an order provisioning operation 214 sends an order containing subscription information to the commerce platform. The subscription information specifies the subscription offer to use for the test tenant. Upon receipt of the order, the commerce platform processes the order in a purchase operation 216. Free subscription offers allow test tenants to subscribe to a service plan without having to actually charge a funding source associated with the test tenant (i.e., without having to make a payment). Nominal fee subscription offers minimize the subscription costs, but may still involve completion of financial transaction before the test tenant is generated. The ability to provision test tenants without payment or with a nominal payment in a production multi-tenant service where tenants are expected to purchase services before workloads are provisioned is beneficial, especially when large numbers of test tenants are created on a regular basis. While special subscriptions offers may be useful to minimize or avoid the need to process financial transactions involving actual funding sources when generating test tenants, the definition and/or use of special subscription offers is not required to generate test tenants.

In various embodiments, the commerce platform considers the account of a test tenant using a free subscription offer to be paid in full. For example, the free subscription offer may cause the commerce platform to issue a credit that offsets the cost of the subscription for the lifespan of the test tenant. In other words, the commerce platform would treat the test tenant as not having a balance due. Because free subscription offers allow the commerce platform forego the collection of a payment from the test tenant, creation of a test tenant may be accomplished without providing a payment source (e.g., credit card or bank routing information). Depending upon the commerce platform, the payment source information may be omitted entirely or fictitious payment source information may be used (e.g., a credit card or bank routing numbers consisting entirely of zeroes).

As previously mentioned, the use of special subscription offers is not required and test tenants may also be provisioned using regular paid subscriptions. In such scenarios, the system may use various mechanisms for negating costs associated with test tenants. For example, the system may provide reimbursement for the service plan for any tenant properly identified as a test tenant. However, payment and reimbursement solutions must be carefully tracked to ensure that the test tenant financial transactions are transparent when reporting actual financials for the multi-tenant service, as well as, requiring sufficient funds to be held in reserve to process the transactions. Similarly, the commerce platform may be modified so that entering certain information bypasses the actual processing of the financial transaction. Such implementations require careful monitoring to avoid allowing real tenants to subscribe without payment and other misuse and, as with reimbursements, requires careful tracking to ensure financial transparency.

Once the purchase is complete, a workload provisioning operation 218 provisions the test tenant for the workloads associated with the subscription offer in the directory service. In various embodiments, the workload, through its service instances, periodically asks for work. In other words, the service instances may be used to query the directory service for updates, such as newly created or updated test tenants. If updated or newly created test tenants exist, they are provisioned to the appropriate service instance, which may be a specific service instance set by the service instance assignment operation or, if the service instance property was not explicitly set, any available service instance matching selected criteria. Depending upon the multi-tenant service, other mechanisms for provisioning test tenants may be used. For example, test tenants may be placed in criteria-based queues on the administrative (e.g., the directory service) side or the workload side or test tenants may be pushed to the appropriate workload or service instance.

Generally, the test tenant is provisioned to a service instance having properties that match selected properties of the test tenant. For example, a tenant with the language property set to French and a region set to Canada subscribing to the mail service workload of the multi-tenant service would be provisioned to a service instance for the mail service workload in a data center in North America configured for the French language. If the service instance property of the tenant has not been set, as in the case of a tenant created for a customer through a publicly accessible registration portal, the tenant may be provisioned in a data center on the east coast or west coast to any service instance for a workload using the French language. By way of example, this may be the result of the service instance property be set automatically by the commerce platform to any available service instance matching selected criteria at the time the order is provisioned to the tenant or by the directory service when a service instance matching selected criteria asks if new tenants are available.

Conversely, when the service instance property has been set prior to an order being placed by the tenant provisioning system, the tenant will be provisioned only to the selected service instance. In other words, the service instance property is not overwritten when the order is placed or by the first service instance matching the properties normally used to assign the service instance to ask for work.

At the end-of-life for a test tenant, a cleanup operation 220 disables and de-provisions the test tenant from the multi-tenant service. The end-of-life of a test tenant may be triggered by the expiration of a special subscription offer. The billing cycle associated with a special subscription offer may be used to define the lifespan of test tenant. In various embodiments, a special subscription offer may be configured to not automatically renew. Alternatively, a test tenant provisioned with fictitious payment source information would result in an unsuccessful collection attempt. In either case, the subscription for the test tenant may be flagged as expired. At a specified amount of time after expiration, the subscription (i.e., the test tenant's access to the workloads) may be disabled. Subsequently, when a period of time after disabling the subscription passes, the test tenant is de-provisioned. For example, a special subscription offer may have a billing cycle of 60 days. Upon the initial non-renewal or non-payment, the subscription is flagged as expired. The billing cycle rules may specify that an expired subscription is disabled 10 days after expiration and that a tenant with a disabled subscription is de-provisioned 10 day after the subscription is disabled. Test tenants may be de-provisioned from the service instances or both the service instances and the directory service (i.e., purged).

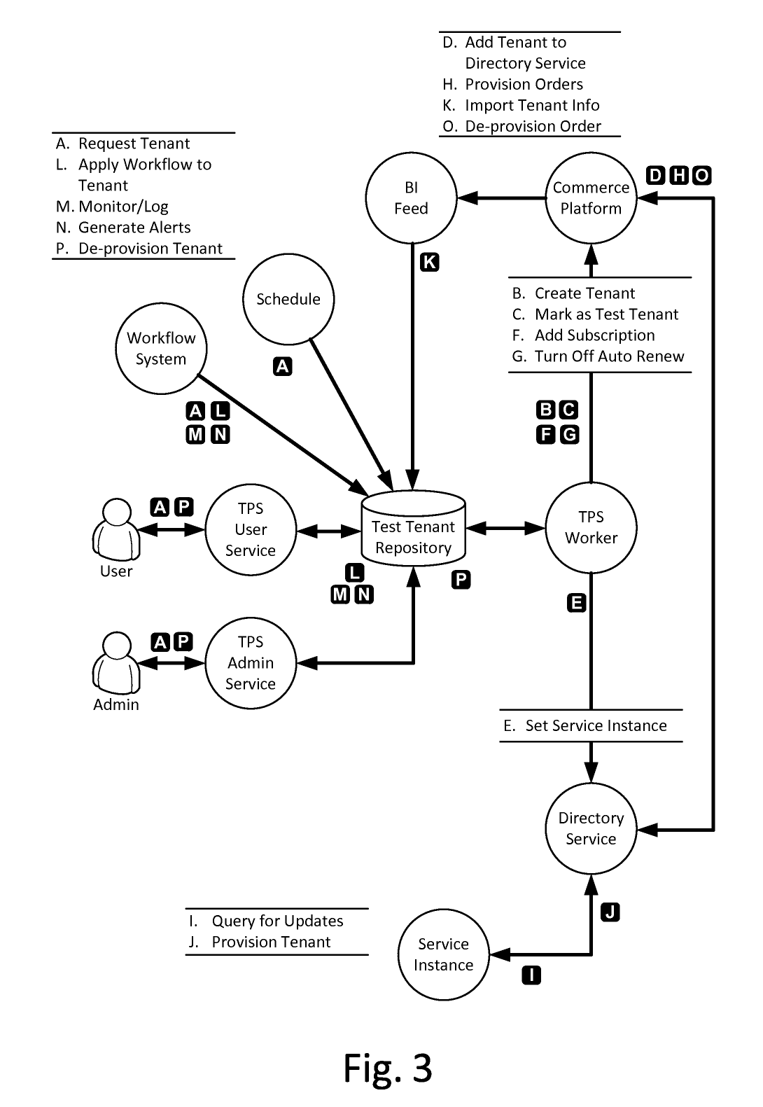

FIG. 3 illustrates the operational flow of one embodiment of the tenant provisioning system to generate test tenants in a selected service instance. Tenant provisioning begins with a prompt to create a tenant (A), which may be received from sources such as a user (e.g., standard and administrative users), an external system (e.g., the workflow system), or a scheduled workflow. The tenant provisioning system establishes communication with the commerce platform associated with the multi-tenant service and initiates creation of a tenant (B). Communications by the tenant provisioning system with external systems may be accomplished by in a various ways, depending on the interfaces provided. For example, the tenant provisioning system may deploy workers (e.g., threads) that directly manipulate the external system, as shown in the illustrated embodiment. Alternatively, the tenant provisioning system may send requests to a web service provided by the external system, make calls to an application programming interface exposed by the external system, or utilize other available communication mechanisms.

The tenant provisioning system tags the tenant (C) in a manner that identifies the tenant as a test tenant. The commerce platform adds the tenant to the directory service (D) for the multi-tenant service. Next, the tenant provisioning system sets the selected service instances (E) for one or more workloads in the tenant in the directory service. Once the service instances for the tenant have been set, the tenant provisioning system places an order (F) with the commerce platform using a selected subscription offer, which may be one of the special/free subscription offers, which may include actions such as turning off auto renewal (G) for the tenant subscription to cause the tenant to expire. Upon completion of the order, the commerce platform provisions the tenant with the workloads included in the subscription (H). The service instances periodically query the directory service for updates (I). If the updates include a new tenant specifying the service instance making the query, the tenant is provisioned for that service instance (J).

Normally, when provisioning a tenant for a customer, the services instances for any workloads to which the customer subscribes are established at the time the subscription plan is provisioned on the tenant based on a mapping algorithm that uses information about or from the customer (e.g., location, language, etc.). In the illustrated embodiment, the multi-tenant service infrastructure contains a mixture of service instances that are not upgrade-ready and some that are. If the intent is to use test tenants to verify that upgrade workflows are properly functioning, it would be not helpful to provision a test tenant in a service instance that is not upgrade-ready. Relying on the mapping algorithm, there is no guarantee that the test tenant will be provisioned in a service instance that is upgrade ready. However, because the tenant provisioning system presets the service instances prior to placing the order, the mapping algorithm is bypassed and the tenant is provisioned using the selected service instances. By setting the service instance of the tenant to an identifier of an upgrade-ready service instance, the tenant is assured of being provisioned in an upgrade-ready service instance so functioning of the upgrade workflow may be verified.

As previously mentioned, embodiments of the tenant provisioning system may act as a repository of information pertaining to test tenants. When automatically provisioning test tenants or provisioning test tenants in bulk, embodiments may use an automated mechanism for importing test tenant information. In various embodiments, automated or bulk test tenant information is provided by a business intelligence feed (K) from the commerce platform. The business intelligence feed reports activities, such as the provisioning of new tenants and the modification of existing tenants. Test tenant information reported in the business intelligence feed may be imported into the tenant provisioning system.

In some embodiments, the business intelligence feed is specific to the tenant provisioning system, and the commerce platform only includes test tenant information by applying filters that use the test tenant identifiers to screen the tenants. In other embodiments, the business intelligence feed is not limited to test tenants, and filters are applied by the tenant provision system to extract and import only the test tenant information.

The business intelligence feed may have a lag between the time that an activity occurs and the time the activity is reported. Accordingly, embodiments of the tenant provisioning system factor the lag into workflows to ensure that relevant information is not missed. In the case of migrating test tenants from one version of a workload to another during an upgrade project to verify operation of an upgrade workflow in selected service instances, test tenants may be provisioned on a regular basis and run through the upgrade workflow. The test tenant information indicating the outcome of the upgrade may not be available for some time, for example, 24-hours to 48-hours, after the test tenant was provisioned. Accordingly, the monitoring of the upgrade workflow may look for test tenants created two days earlier.

Test tenants generated may be used in a variety of ways, including heartbeat monitoring, sharing the customer experience, compatibility testing, troubleshooting, and demonstrating workloads, service instances, workflows, and applications in the multi-tenant service. Generally, monitoring operations involve a applying a workflow to the test tenant (L) and logging or otherwise reporting the workflow outcome (M). If errors occur, alert may be generated (N) to notify appropriate personnel (e.g., engineering).

Heartbeat monitoring typically involves generating an ongoing series of test tenants to ensure that a service instance is functioning properly. Heartbeat testing applies workflows to test tenants to verify that the workflow is successfully completing. If the workflow is unsuccessful for the test tenant, alerts may be raised. Continuously monitoring the heartbeat using test tenants provides an opportunity to detect and resolve problems before customer are affected.

The customer experience for a given workflow may differ between different service instances due to various factors, such as running different versions or builds of the workload or having different configurations. Customer experience monitoring allows workflow developers to experience what customers on a selected service instance experience. Based on the results of user experience monitoring, the workflow developer may modify a workflow for some or all of the service instances.

In one example, test tenants may be used to verify that an upgrade workflow is functioning properly in a selected service instance when migrating tenants from one version of a workload to another. Upgrade workflow monitoring may be used on an as-needed basis by generating a test tenant in a selected service instance and applying the upgrade workflow to verify proper operation of the upgrade workflow in the selected service instance before applying the upgrade workflow to real tenants in the selected service instance. Upgrade workflow monitoring may also be implemented as heartbeat monitoring by creating test tenants on a regular basis (e.g., every four hours) in selected service instances and applying the upgrade workflow to verify that the upgrade workflow is working for the selected service instance.

In another example, a workload may verify its provisioning workflow using a regular stream of test tenants. Test tenants are created in various service instances of the workload and the workload-level provisioning workflow is applied to verify that tenant provisioning at the workload level is functioning properly.

In another example, connectivity between mail clients and the mail server in the multi-tenant service is important to users of the multi-tenant service and presents one of the larger support issues for providers of multi-tenant services. Test tenants may be generated to test communication between mail service forests from different versions of the mail servers and mail clients and between mail service forests from different service instances.

Verification of the operation of an application running on framework provided by a workload provides another example of monitoring using test tenants. Test tenants are created in various service instances of the workload and tested with the application to verify that the application is functioning properly in those service instances. Application verification may be used for testing compatibility with various service instance configurations during development and deployment and for on-going (i.e., heartbeat) monitoring of the operational status of the application.

Test tenants may also be used by engineering to troubleshoot the multi-tenant service, workloads, and/or service instances. For example, in response to a reported problem with a service instance, test tenants may be created in that selected service instance to allow the engineer to attempt to recreate and diagnose the reported problem. After making changes, test tenants may be used to verify that the problem has been resolved. Troubleshooting using test tenants allows engineering to be more responsive, resolve problems faster, and have greater assurance that changes have resolved the problem, all without requiring access to real tenant data.

Similarly, test tenants may also be used by technical support when responding to requests from customers. For example, when a user calls into the help desk for the multi-tenant service, technical support personnel can utilize test tenants created in the same service instance as the real tenant. Thus, technical support personnel will have the same experience as the user, including any peculiarities of the particular service instance, when assisting the user. In addition, the use of test tenants in the same service instance as the real tenant allows technical support personnel to determine if the issue experienced by the user is a systemic issue affecting all users of the service instance or a customer specific issue. If technical support personnel encounter the same result using the test tenant as the user is experiencing, the issue may be deemed systemic. Conversely, if the test tenant does not encounter the problem that the user is experiencing, the issue may be deemed to be specific to the real tenant.

A further example is the use of test tenants to demonstrate the multi-tenant service in various markets. Sales and marketing personnel can use test tenants created in a selected service instance to show potential customers exactly what they can expect.

Test tenants may also be used to verify the configuration of a selected service instance. As service instances are configured or upgraded, test tenants may be used to monitor the experience. For example, a new build of a workload may include a number of changes. The changes may be introduced in different flights exposing different sets of changes. Test tenants may be created in the various service instances. Once the flights have been deployed, validation workflows may be used to verify that the various service instances received the proper version and build and that the features are properly exposed or disabled. If test tenants in a selected service instance have access to features that should be disabled or cannot access features that should be enabled, an alert may be generated.

Finally, the commerce system may deactivate/de-provision the subscription (O) at the expiration of the special subscription offer. A tenant with no active subscription may be automatically de-provisioned and purged (P) during cleanup. Tenants may also be manually de-provisioned and/or purged by user action.

The subject matter of this application may be practiced in a variety of embodiments as systems, devices, and other articles of manufacture or as methods. Embodiments may be implemented as hardware, software, computer readable media, or a combination thereof. The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

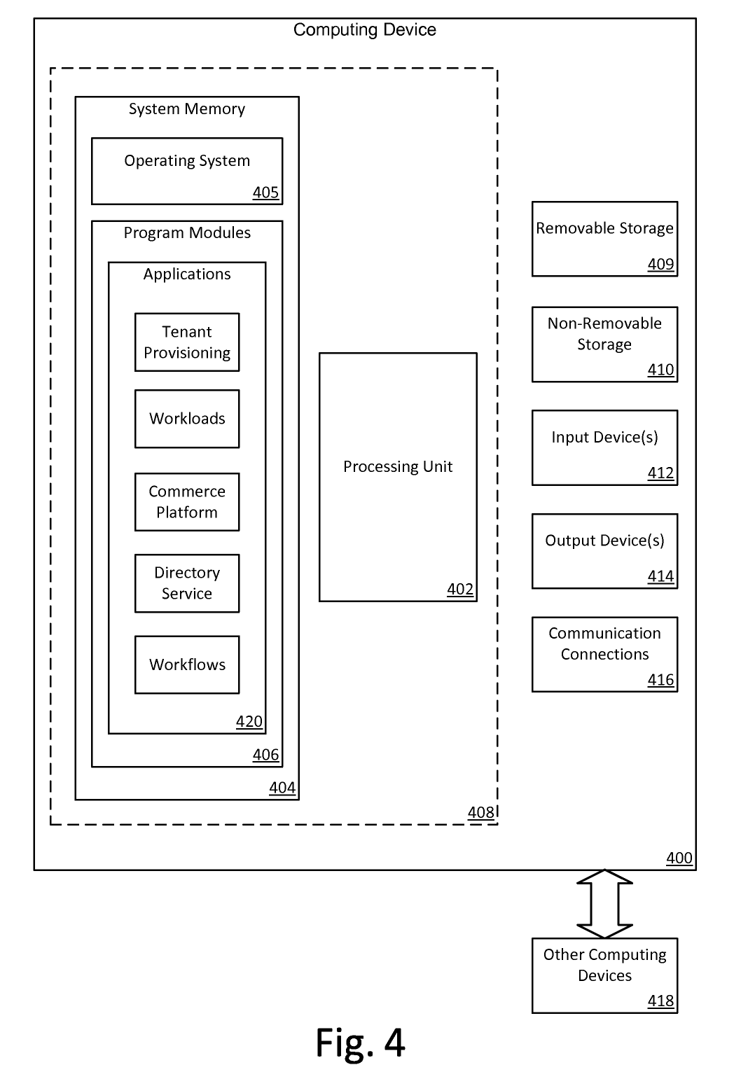

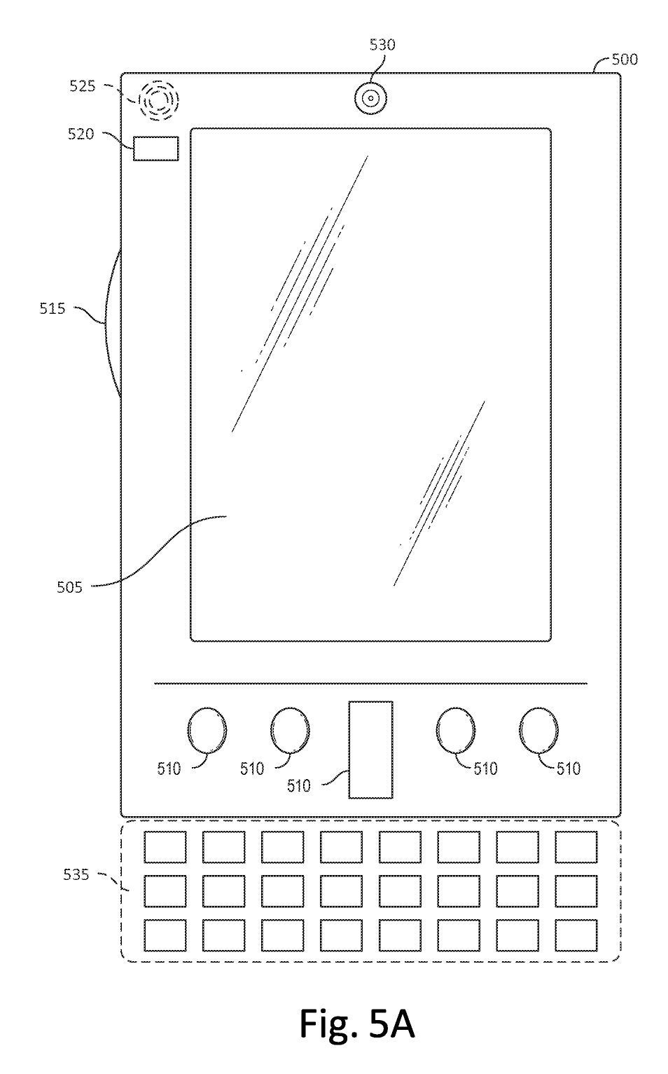

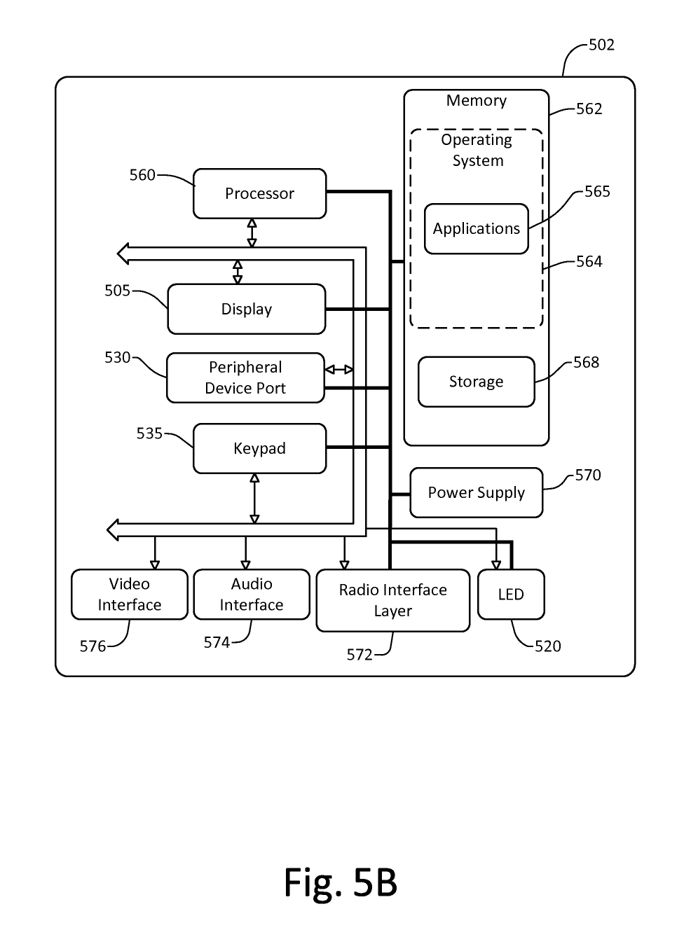

FIGS. 4 and 5 and the associated descriptions provide a discussion of a variety of operating environments in which embodiments of the invention may be practiced. However, the devices and systems illustrated and discussed are for purposes of example and illustration and are not limiting of a vast number of computing device configurations that may be utilized for practicing embodiments of the invention described above.

FIG. 4 is a block diagram illustrating physical components (i.e., hardware) of a computing device 400 with which embodiments of the invention may be practiced. The computing device components described below may be suitable for embodying computing devices including, but not limited to, a personal computer, a tablet computer, a surface computer, and a smart phone, or any other computing device discussed herein. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 420, such as components of the tenant provisioning system 100, the multi-tenant service 102 (e.g., workloads, service instances), the directory service 110, the commerce platform 112, workflow services, and business intelligence services. For example, the operating system 405 may be suitable for controlling the operation of the computing device 400. Furthermore, embodiments of the invention may be practiced in conjunction with a graphics library, other operating systems, or any other application program and is not limited to any particular application or system. This basic configuration is illustrated by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated by a removable storage device 409 and a non-removable storage device 410.

As stated above, a number of program modules and data files may be stored in the system memory 404. While executing on the processing unit 402, the software applications 420 may perform processes including, but not limited to, one or more of the stages of the tenant provisioning method 200. Other program modules that may be used in accordance with embodiments of the present invention may include electronic mail and contacts applications, word processing applications, spreadsheet applications, database applications, slide presentation applications, drawing applications, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the illustrated components may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein with respect to the software applications 420 may be operated via application-specific logic integrated with other components of the computing device 400 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all examples of computer storage media (i.e., memory storage). Computer storage media may include random access memory (RAM), read only memory (ROM), electrically erasable read-only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400.

FIGS. 5A and 5B illustrate a mobile computing device 500 with which embodiments of the invention may be practiced. Examples of suitable mobile computing devices include, but are not limited to, a mobile telephone, a smart phone, a tablet computer, a surface computer, and a laptop computer. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. In alternative embodiments, mobile computing device 500 may incorporate more or less input elements. For example, the display 505 may not be a touch screen in some embodiments. In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display. In various embodiments, the output elements include the display 505 for showing a graphical user interface, a visual indicator 520 (e.g., a light emitting diode), and/or an audio transducer 525 (e.g., a speaker). In some embodiments, the mobile computing device 500 incorporates a vibration transducer for providing the user with tactile feedback. In yet another embodiment, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one embodiment of a mobile computing device. That is, the mobile computing device 500 can incorporate a system (i.e., an architecture) 502 to implement some embodiments. In one embodiment, the system 502 is implemented as a smart phone capable of running one or more applications (e.g., browsers, e-mail clients, notes, contact managers, messaging clients, games, and media clients/players). In some embodiments, the system 502 is integrated as a computing device, such as an integrated personal digital assistant (PDA) and wireless phone.

One or more application programs 565 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 565 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500, including software applications 420 described herein.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the outside world via a communications carrier or service provider. Transmissions to and from the radio 572 are conducted under control of the operating system 564. In other words, communications received by the radio 572 may be disseminated to the application programs 565 via the operating system 564, and vice versa.

The visual indicator 520 may be used to provide visual notifications, and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present invention, the microphone may also serve as an audio sensor to facilitate control of notifications, as will be described below. The system 502 may further include a video interface 576 that enables an operation of an on-board camera 530 to record still images, video streams, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

The description and illustration of one or more embodiments provided in this application are intended to provide a complete thorough and complete disclosure the full scope of the subject matter to those skilled in the art and not intended to limit or restrict the scope of the invention as claimed in any way. The embodiments, examples, and details provided in this application are considered sufficient to convey possession and enable those skilled in the art to practice the best mode of claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for automated provisioning of a test tenant in a production multi-tenant service, the multi-tenant service providing one or more workloads through multiple service instances, the method comprising the acts of:
creating a test tenant to be provisioned in a selected service instance of a workload of the multi-tenant service;
assigning the test tenant to a selected service instance; and
provisioning the test tenant with a selected subscription offer in the selected service instance.

2. The method of claim 1 wherein the selected service instance is associated with a selected network, farm, tree, or forest.

3. The method of claim 1 wherein the act of provisioning the test tenant further comprises the act of passing metadata comprising one or more selected characteristics to a system associated with the multi-tenant service instructing the associated system how to provision the test tenant.

4. The method of claim 3 wherein the act of provisioning the test tenant further comprises the act of instructing the associated system to skip billing for the test tenant.

5. The method of claim 3 wherein the act of provisioning the test tenant further comprises the act of instructing the associated system to identify the test tenant as a test tenant in the multi-tenant system.

6. The method of claim 3 wherein the act of provisioning the test tenant further comprises the act of instructing the associated system to use a selected workload version or a selected database.

7. The method of claim 1 further comprising the act of automatically generating test tenants for selected service instances according to a schedule or on a periodic basis.

8. The method of claim 1 further comprising the act of providing a free subscription offer for subscribing a test tenant to a workload without requiring payment, the free subscription offer only being available to test tenants; and
wherein the selected subscription offer is the free subscription offer.

9. The method of claim 1 further comprising the act of testing an upgrade workflow in a selected service instance by upgrading a test tenant in the selected service instance.

10. The method of claim 1 further comprising the act of testing a provisioning workflow for a selected service instance by provisioning the test tenant in the selected service instance.

11. The method of claim 1 further comprising the act of testing an application built on top of an application framework in the selected service instance using the test tenant in the selected service instance.

12. The method of claim 1 further comprising the act of testing a flow of communications between a mail client provided by the selected service instance and a mail server by sending communications to the test tenant in the selected service instance.

13. A system for provisioning of test tenants in a production multi-tenant service, the multi-tenant service providing one or more workloads through multiple service instances, the system comprising a processor and a memory for storing computer readable instructions that, when executed by the processor, are operable to:
initiate creation of a tenant in the multi-tenant service, wherein the tenant is not associated with a customer; and
assign a selected service instance to the tenant before provisioning the tenant; and
provision the tenant in the selected service instance.

14. The system of claim 13 further comprising a commerce platform system associated with the multi-tenant service, the commerce platform system storing free subscription offers allowing access to selected workloads without requiring payment, wherein the system initiates creation of the tenant through the commerce platform system and is further operable to place an order with the commerce platform system to obtain access to selected workloads using one of the free subscription offers, and wherein commerce platform system provisions the tenant with the selected workloads.

15. The system of claim 14 further comprising a directory service system associated with the multi-tenant service operable to store the test tenant, wherein the system communicates with the directory service system to assign the selected service instance to the tenant before placing the order with the commerce platform system.

16. The system of claim 14 wherein the commerce platform system generates a business intelligence feed reporting information about the test tenant.

17. The system of claim 13 further comprising a workflow system storing a workflow associated with a workload, the workflow system operable to apply the workflow to the tenant in the selected service instance, verify successful operation of the workflow, and generate alerts upon failure of the workflow.

18. The system of claim 13 wherein the system is further operable to accept requests for tenants provisioned in selected service instances from users.

19. The system of claim 13 wherein the system is further operable to automatically provision tenants in selected service instances on a periodic basis or according to a schedule.

20. A computer readable medium containing computer executable instructions which, when executed by a computer, perform a method of provisioning test tenants in a production multi-tenant service, the multi-tenant service providing one or more workloads through multiple service instances, the method comprising the acts of:
adding a special subscription offer to a commerce platform associated with provisioning tenants, the special subscription offer associated with access to a selected workload;
creating a test tenant in the multi-tenant service through a commerce platform associated with the multi-tenant service;
configuring the test tenant to be provisioned in a selected service instance of a selected workload;
after configuring the test tenant, placing an order for access to the selected workload by the test tenant using the special subscription offer; and
provisioning the test tenant with the special subscription offer in the selected service instance.
